(19) United States
(12) Patent Application Publication
(10) Pub. No.: US 2015/0248704 A1
(43) Pub. Date: Sep. 3, 2015

(54) METHOD FOR DISTRIBUTING INFORMATION TO A MOBILE DEVICE CARRIED BY A USER

(71) Applicant: TOSHIBA TEC KABUSHIKI KAISHA, Tokyo (JP)

(72) Inventors: Akihiko FUJIWARA, Kawasaki Kanagawa (JP); Mika HIRAMA, Kokubunji Tokyo (JP); Masaaki YASUNAGA, Suntou Shizuoka (JP); Tetsuya NOBUOKA, Suntou Shizuoka (JP)

(21) Appl. No.: 14/632,851

(22) Filed: Feb. 26, 2015

(30) Foreign Application Priority Data
Feb. 28, 2014 (JP) 2014-038017

(51) Int. Cl. G06Q 30/02; H04W 40/24

(52) U.S. Cl. CPC G06Q 30/0267; H04W 40/244

(57) ABSTRACT

A method for distributing information to a mobile device carried by a user within a service location, includes transmitting a first signal through one or more transmitters at the service location, in response to the first signal, receiving from a mobile device that is in range of the transmitters, a second signal containing information about the mobile device or a user of the mobile device, determining content of information related to services offered at the service location, based on the received information, and transmitting a third signal containing the determined content to the mobile device.

### CROSS-REFERENCE TO RELATED APPLICATION

This application is based upon and claims the benefit of priority from Japanese Patent Application No. 2014-038017, filed Feb. 28, 2014, the entire contents of which are incorporated herein by reference.

### FIELD

Embodiments described herein relate generally to a method for distributing information to a mobile device carried by a user.

### BACKGROUND

There is a technique for distributing information to mobile devices carried by users in commercial facilities such as a store, a shopping mall or an event site. According to the technique, a transmitter (beacon transmitter, i-beacon transmitter, or the like) that transmits a radio wave for wireless communication is provided in the commercial facilities and service information such as reward points, a coupon, or an event schedule is transmitted through the transmitter to the mobile devices. The user of the mobile device, however, may not be interested in receiving all of transmitted information.

### DESCRIPTION OF THE DRAWINGS

FIG. 1 illustrates an information distribution system according to an exemplary embodiment.

FIG. 2 is a block diagram of the information distribution system focusing on configuration of a server included in the system.

FIG. 3 illustrates each data example of terminal information and transmitter information stored in the server according to an exemplary embodiment.

FIG. 4 illustrates an example of condition definition data stored in the server according to an exemplary embodiment.

FIG. 5 is a flowchart illustrating an operation carried out by the server according to an exemplary embodiment.

### DETAILED DESCRIPTION

An exemplary embodiment provides a technique capable of distributing information according to preference of a customer.

In general, according to one embodiment, a method for distributing information to a mobile device carried by a user within a service location, includes transmitting a first signal through one or more transmitters at the service location, in response to the first signal, receiving from a mobile device that is in range of the transmitters, a second signal containing information about the mobile device or a user of the mobile device, determining content of information related to services offered at the service location, based on the received information, and transmitting a third signal containing the determined content to the mobile device.

In an exemplary embodiment, service information determined based on a purchase tendency (preference of low price over high quality, preference of high quality over low price, or the like), taste, or attributes (age, gender or the like) of a user of a portable terminal device is distributed. In the exemplary embodiment, the service information refers to information such as a floor guide or a map in commercial facilities, time sale information, a guide of service target merchandise such as highly recommended merchandise, a coupon, a guide of an event schedule, for example. Further, a service provider such as a store or an event sponsor may distribute service information with high priority of provision or high importance.

In the exemplary embodiment, when distributing information to a portable terminal device of a user through communication with a transmitter, the information distribution apparatus may select content of the information according to expected preference of the user. Thus, it is possible to perform more useful information distribution to the user.

Hereinafter, the exemplary embodiment will be described with reference to the accompanying drawings. In the following description, the method according to the exemplary embodiment is applied to a shopping mall as an example, but the method may be applied to other commercial facilities such as a single store or an event site.

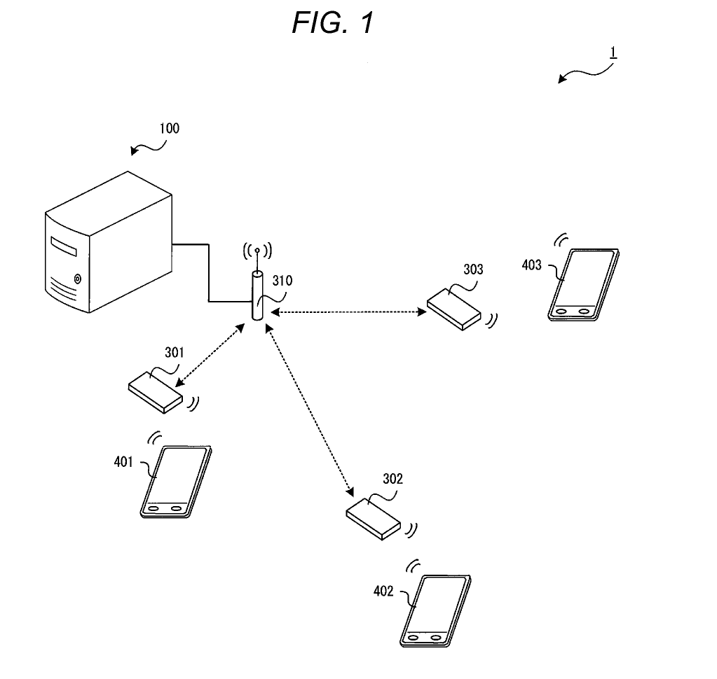

FIG. 1 illustrates configuration of an information providing system according to an exemplary embodiment. An information distribution system 1 includes a server 100, an access point 310, and transmitters 301 to 303. The server 100 and the access point 310 are connected to each other through a local area network (LAN) cable, for example. The access point 310 and the transmitters 301 to 303 are connected to each other through a wireless communication LAN (see broken line arrows in FIG. 1). Thus, the server 100 and the transmitters 301 to 303 may perform data transmission and reception through the access point 310. The type of the communication between the server 100 and the transmitters 301 to 303 is not limited thereto, and may employ wired connection or other wireless communication methods. Further, the number of the devices (the number of servers, the number of transmitters, the number of portable terminal devices, or the like) illustrated in FIG. 1 and the following description is not limited.

The transmitters 301 to 303 distribute service information or the like to portable terminal devices 401 to 403 carried by store visitors in a push type manner. The transmitters 301 to 303 are located at any place in a commercial facility accommodating plural stores. The location may be a passage that store visitors pass, the inside of a store, an information desk, a service counter, a resting place, or any other places the store visitors may enter. An internal configuration of each of the transmitters 301 to 303 may be any configuration that may perform wireless communication with the portable terminal devices 401 to 403 and may perform communication with the server 100. For example, a configuration obtained by combining plural application specific integrated circuits (ASICs), or a device in which plural ASICs are assembled may be used. Further, a unit that performs wireless communication with the portable terminal devices 401 to 403 may be connected to a small computer such as a notebook-type computer and wired or wireless communication may be performed with respect to the server 100 (in this example, the wireless communication is performed through the access point 310).

The server 100 is a computer that provides service information to the portable terminal devices 401 to 403 through the access point 310. Further, the server 100 acquires attribute information (age, gender, and purchase tendency) transmitted from the portable terminal devices 401 to 403 through the access point 310 or the transmitters 301 to 303, and distributes service information according to the attribute information. Furthermore, the server 100 may determine whether the user is interested in a place (disposed in the vicinity of the disposition position of the transmitters 301 to 303 (for example, a merchandise bulletin board or a show window), based on the intensity of a signal from the transmitters 301 to 303 detected by the portable terminal devices 401 to 403, or a time period during which the intensity is maintained.

The access point 310 is a communication base device for wireless communication between the server 100 and the transmitters 301 to 303. In the exemplary embodiment, the access point 310 performs communication based on the standard of IEEE802.11, and performs encryption communication.

The portable terminal devices 401 to 403 are typically smart phones carried by store visitors, or passersby (hereinafter, collectively referred to as users as needed), but may be notebook-type computers, tablet-type computers, or the like. It is assumed that the portable terminal devices 401 to 403 are able to perform at least wireless communication and that an application exclusively used for an information distribution system 1 is preinstalled therein.

The exclusive application preinstalled in the portable terminal devices 401 to 403 may detect a signal (beacon) from the transmitters 301 to 303 and calculate the intensity of the signal. Further, when the exclusive application is installed and then an initial start is performed, the portable terminal devices 401 to 403 acquire attribute information of a user and store the attribute information in a storage unit of the devices. The attribute information includes the gender, the age, the purchase tendency, and the like of the user. The purchase tendency includes preference of price over quality, preference of quality over price, preference of high-price products, or the like. When acquiring the attribute information, the portable terminal devices 401 to 403 display a direct or indirect inquiry, and store a response obtained from a user in the storage unit. Further, the exclusive application also includes a web browser function.

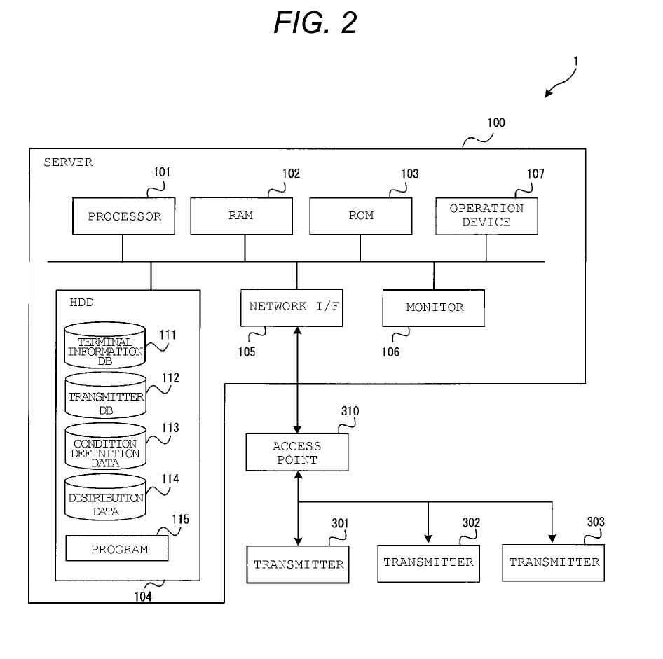

A configuration of the server 100 will be described with reference to FIG. 2. The server 100 includes a processor 101, a random access memory (RAM) 102, a read only memory (ROM) 103, a hard disk drive (HDD) 104, a network interface (I/F) 105, a monitor 106, and an operation device 107. The processor 101 is an arithmetic unit such as a central processing unit (CPU). The processor 101 develops a program stored in the ROM 103 or a program 115 stored in the HDD 104 to the RAM 102 to execute an arithmetic operation, to thereby provide various functions in cooperation with each hardware. The RAM 102 is a main storage unit, and the ROM 103 is a memory unit that stores a system program or the like executed when power is turned on in a nonvolatile manner. The HDD 104 is an auxiliary memory unit that stores a program, data or the like in a nonvolatile manner. The network I/F 105 is a LAN board and performs communication with the access point 310. The monitor 106 and the operation device 107 (for example, a keyboard or a mouse) serve as an operational display unit when a manager or the like of the server 100 performs maintenance.

In the HDD 104, a terminal information database (DB) 111, a transmitter DB 112, condition definition data 113, distribution data 114, and the program 115 are stored in advance. The terminal information database (DB) 111, the transmitter DB 112, and the condition definition data 113 will be described below. The distribution data 114 is an entity data group to be distributed to the portable terminal devices 401 to 403, and is collected in a folder for each content to be distributed. The entity data has the same format as a format used in an existing web system, and includes layout data, image data for display, a script to be executed in the portable terminal devices 401 to 403, or the like. The program 115 is a program that is operated when a detection signal from the portable terminal devices 401 to 403 is received, which is a program group that provides a web server function.

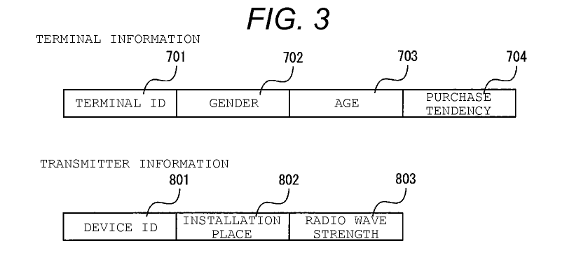

Next, a variety of data of the terminal information DB 111, the transmitter DB 112, and the condition definition data 113 will be described. FIG. 3 illustrates columns of a table stored in the terminal information DB 111 in an upper part thereof, and illustrates columns of a table stored in the transmitter DB 112 in a lower part thereof. The terminal information DB 111 stores a variety of data including a terminal ID 701, a gender 702, an age 703, and a purchase tendency 704. The terminal ID 701 is information for identifying the portable terminal devices 401 to 403 carried by the users. The identification information includes a telephone number, a device specific MAC address, information automatically numbered to be unique in the information distribution system 1, or the like. The gender 702, the age 703, and the purchase tendency 704 are values input when the user initially starts the application. In addition, a column in which information that a service provider desires to collect, such as user visiting date and time or visit frequency, or management data is written may be provided.

In the transmitter DB 112, a variety of data including a device ID 801, an installation place 802, and a radio wave strength 803 is stored. The device ID 801 is identification information of the transmitters 301 to 303, and the installation place 802 is an installation place of the transmitters 301 to 303 in a facility. The radio wave strength 803 represents a design value or an actual value of a beacon generation strength of each of the transmitters 301 to 303, which is set to a strength when measurement is performed at a place separated from the transmitter that is a measurement target by a predetermined distance (for example, 5 m). Each value of the transmitter information is set when the information distribution system 1 is introduced, or when maintenance is performed.

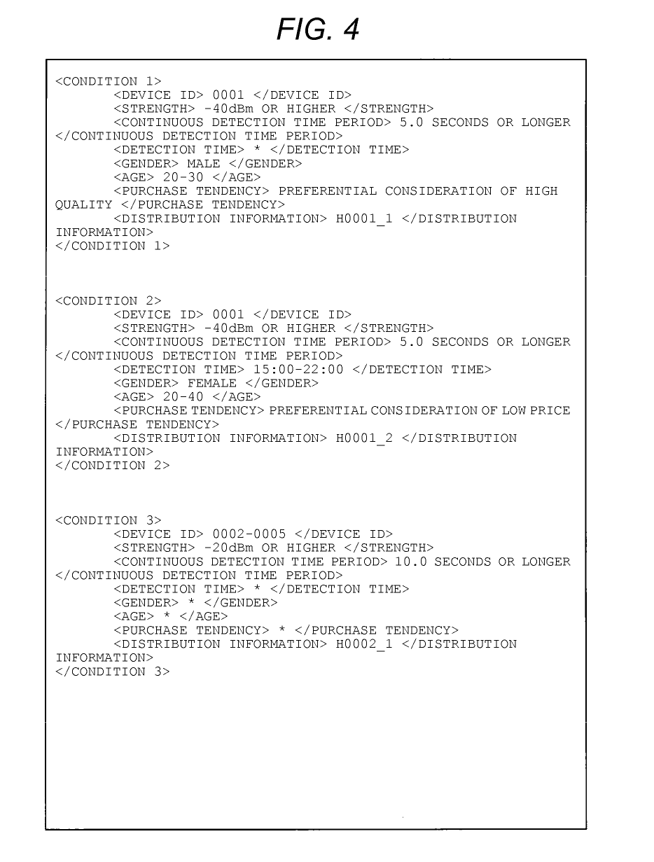

The condition definition data 113 is defined using a predetermined markup language. An example thereof is illustrated in FIG. 4. The server 100 determines whether to distribute service information to the portable terminal devices 401 to 403 based on conditions defined in the condition definition data 113. Further, if it is determined that the service information is to be distributed, the server 100 determines which service information is to be distributed. The determination is performed based on the device IDs of the transmitters 301 to 303, the detected radio wave strength, a continuous detection time period, a detection time, and the attribute information (gender, age and purchase tendency).

For example, condition 1 in FIG. 4 is defined as follows.
The portable terminal device is continuously positioned for 5 seconds or longer in a range where the radio wave strength of the transmitter of which the device ID is “0001” is −40 dBm or higher.
The beacon detection time does not matter (* represents any time).
The registered attribute information of the portable terminal device is that the gender is male, the age is twenty to thirty, and the purchase tendency is preference of high quality (over low price).

When the entirety of the above condition is satisfied, data included in a folder name “H0001_{—}1” in the distribution data 114 is distributed.

Further, condition 2 is defined as follows.
The portable terminal device is continuously positioned for 5 seconds or longer in a range where the radio wave strength of the transmitter of which the device ID is “0001” is −40 dBm or higher.
The beacon detection time is within a range of 15:00 to 22:00.
The registered attribute information of the portable terminal device is that the gender is female, the age is twenty to forty, and the purchase tendency is preference of low price (over high quality).

When the entirety of the above condition is satisfied, data included in a folder name “H0001_{—}2” in the distribution data 114 is distributed.

Condition 3 is as follows. That is, when the portable terminal device is continuously positioned for 10 seconds or longer in the vicinity of the transmitter of which the device ID is any one of “0002” to “0005” in a range where the radio wave strength is −20 dBm, data included in a folder name “H0002_{—}1” in the distribution data 114 is distributed regardless of the beacon detection time and the attribute information.

In the terminal information DB 111 and the transmitter DB 112, the information is stored as a form of a database table, and in the condition definition data 113, the information is stored in the markup language form. However, the exemplary embodiment is not limited thereto, and the storage may be in any form. Further, in the distribution data 114, the distribution information is collected in the unit of the folder, but the exemplary embodiment is not limited thereto.

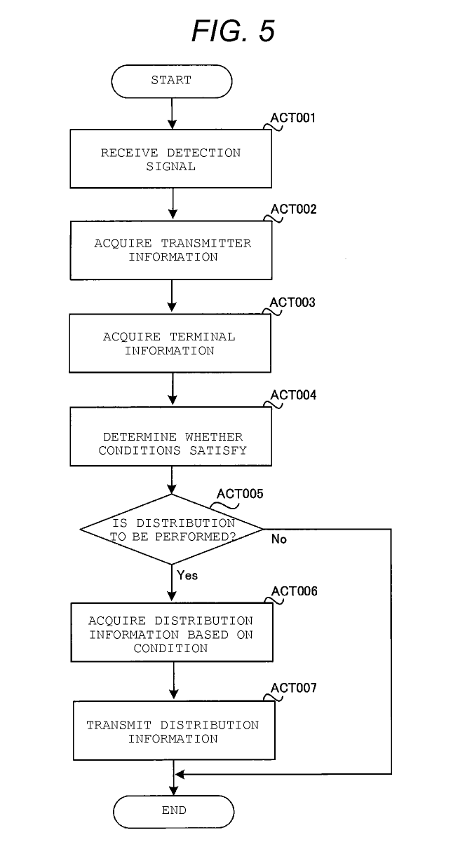

Next, an operation example of the server 100 will be described with reference to a flowchart of FIG. 5. Respective operations are achieved as the processor 101 develops the program 115 stored in the HDD 104 in advance to the RAM 102 and executes an arithmetic operation. Further, it is assumed that the portable terminal device that is detected in this example is the portable terminal device 401. Furthermore, it is assumed that the wireless communication function of the portable terminal device 401 is effective, that the exclusive application has been already installed, and that the setting of the attribute information or the like is completed.

The processor 101 receives access information from the portable terminal device 401, which is transmitted when the portable terminal device 401 detects a signal through the network I/F 105 (ACT 001).

ACT 001 will be described in detail. As a store visitor enters a range that radio waves of the transmitters 301 to 303 located in plural places in the facility reach, the portable terminal device 401 detects a beacon signal. The portable terminal device 401 acquires the device ID of the transmitters 301 to 303 from the detected signal, calculates the strength of the radio wave from the transmitter (for example, the transmitter 301), and transmits access information to the server 100 through the transmitter 301. The access information includes the device ID of the transmitter 301, the radio wave strength, and the device ID of the portable terminal device 401. Further, when a user visits the store for the first time, the set attribute information (gender, age, and purchase tendency) may also be included in correlation with the access information for new registration. The radio wave strength may be a value obtained by calculating a representative value (for example, an average value or the like) of plural measured values. Further, ACT 001 may be performed any time at an interval of 1 second or shorter.

The processor 101 acquires the device ID of the transmitter 301 from the access information (ACT 002), and acquires terminal information (ACT 003). The terminal information acquires the attribute information of the gender, the age, and the purchase tendency related to the terminal ID in the access information, from the terminal information DB 111 using the terminal ID. When the terminal ID is not registered in the terminal information DB 111, that is, when the user is a new store visitor, the currently acquired attribute information is newly registered in the terminal information DB 111 in correlation with the terminal ID.

The processor 101 determines whether to distribute service information based on the condition definition data 113, and determines, if it is determined that the service information is to be distributed, which service information is to be distributed (ACT 004). In the example in FIG. 4, the processor 101 determines whether respective values of the device ID, the radio wave strength, the continuous detection time period, the detection time, the gender, the age, and the purchase tendency obtained based on the respective operations described above are all satisfied for each of the conditions 1 to 3.

With respect to the continuous detection time, in ACT 001, since the access information is acquired at a certain cycle that is less than 1 second, the processor 101 may determine whether the portable terminal device 401 is continuously in a state that satisfies the condition. Further, the detection time may be determined by referring to a time (approximately current time) when the access information has been acquired. The continuous detection time period and the detection time may be measured by the exclusive application of the portable terminal device 401, and then, may be transmitted to the server 100 in a state of being included in the access information. Further, the transmitter 301 may measure the continuous detection time period, the detection time, and the radio wave strength, and then, may transmit the continuous detection time period, the detection time, and the radio wave strength to the server 100.

With respect to the radio wave strength, the processor 101 may acquire the value of the radio wave strength 803 of the transmitter 301 from the transmitter DB 112, may correct the radio wave strength obtained in ACT 001 using the value, and may determine whether the corrected value satisfies the conditions. Information to be acquired is a distance from the transmitter 301 to the portable terminal device 401, which is represented as the radio wave strength. In the exemplary embodiment, the radio wave strength is used as an index of the distance. Accordingly, the value of the radio wave strength 803 in the transmitter DB 112 and the value of the radio wave strength obtained in ACT 001 may be substituted into a predetermined formula to calculate the distance. In this case, a “strength” tag illustrated in FIG. 4 is changed into a “distance” tag, and the value converted into the distance becomes an attribute value in the tag.

If all the conditions (conditions 1 to 3) designated in the condition definition data 113 are not satisfied (No in ACT 005), the process is terminated. On the other hand, if one or plural conditions are satisfied (Yes in ACT 005), the processor 101 acquires service information according to the condition or conditions from the distribution data 114 (ACT 006), and distributes the service information (ACT 007). For example, when the portable terminal device 401 satisfies condition 1 illustrated in FIG. 4, respective pieces of data in the folder H0001_{—}1 that is a value of a “distribution information” tag are distributed. When plural conditions are satisfied, the service information based on any one condition (for example, an initially matched condition) may be distributed, or the service information based on all the satisfied plural conditions may be distributed. As the distribution, push-type distribution may be performed through the transmitter 301. The portable terminal device 401 that receives such service information may visually recognize the distributed service information using the web browser installed in the exclusive application.

Instead of the push-type distribution, the web browser of the portable terminal device 401 may access the web server of the server 100. In this case, the information distributed in ACT 007 has the folder name of “H0001_{—}1” or the like, for example. In the exclusive application of the portable terminal device 401, as a prefix of a URL password, for example, “http://192.168.1.10/beaconid/”, or a global IP address or a URL for public line communication is set. A folder name to be distributed is added to the fixed password to form an access password to the web server.

Further, when the same portable terminal device accesses the server 100 again after the service information that satisfies the conditions once is distributed, the same service information may be distributed again. In order to avoid this problem, a restriction for preventing the service information distributed once from being re-distributed on the same day, for example, may be performed. For example, by storing the terminal ID, the distributed information (folder name or the like), and the distribution date and time in the server 100 in correlation, and by checking the storage content before distribution, the restriction may be performed.

In the exemplary embodiment, the function for achieving the exemplary embodiment is stored in the apparatus in advance, but the exemplary embodiment is not limited thereto, and the same function may be downloaded to the apparatus from the network, or the same function may be stored in a recording medium to be installed to the apparatus. As the recording medium, any type of a recording medium capable of storing a program such as a CD-ROM and capable of being read by the apparatus may be used. Further, functions that may be obtained by installation or downloading in advance may be achieved in cooperation with an operating system (OS) or the like in the apparatus.

As described above, in the exemplary embodiment, it is possible to distribute information according to preference of a user. Thus, it is possible to promote purchase of a product or participation to an event by the user. Further, the system according to the embodiment may be able to promote use of the system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for distributing information to a mobile device carried by a user within a service location, comprising:
transmitting a first signal through one or more transmitters at the service location;
in response to the first signal, receiving from a mobile device that is in range of the transmitters, a second signal containing information about the mobile device or a user of the mobile device;
determining content of information related to services offered at the service location, based on the received information; and
transmitting a third signal containing the determined content to the mobile device.

2. The method according to claim 1, wherein
the service location is a store, and
the content of the information includes information related to a promotion program of the store.

3. The method according to claim 2, wherein
the content of the information includes a link to a web page related to the promotion program.

4. The method according to claim 1, wherein
the information about the mobile device includes intensity of the first signal detected by the mobile device, and
the content of the information is determined based on the intensity of the first signal.

5. The method according to claim 4, wherein
the content of the information is determined based on a time period during which the received intensity is greater than a predetermined value.

6. The method according to claim 1, wherein
the information about the mobile device includes time in a day when the first signal is detected by the mobile device, and
the content of the information is determined based on the time.

7. The method according to claim 1, wherein
the information about the user includes age, gender, purchase tendency of the user, and
the content of the information is determined based on at least one of the age, the gender, and the purchase tendency of the user.

8. The method according to claim 1, further comprising:
storing information about the user including age, gender, purchase tendency of the user in association with identification information of the mobile device used by the user, wherein
the information about the mobile device includes the identification information, and
the content of the information is determined based on the information stored in association with the received identification information.

9. A non-transitory computer readable medium comprising a program that is executable in a computing device to cause the computing device to perform a method for distributing information to a mobile device carried by a user within a service location, the method comprising:
transmitting a first signal through one or more transmitters at the service location;
in response to the first signal, receiving from a mobile device that is in range of the transmitters, a second signal containing information about the mobile device or a user of the mobile device;
determining content of information related to services offered at the service location, based on the received information; and
transmitting a third signal containing the determined content to the mobile device.

10. The non-transitory computer readable medium according to claim 9, wherein
the service location is a store, and
the content of the information includes information related to a promotion program of the store.

11. The non-transitory computer readable medium according to claim 10, wherein
the content of the information includes a link to a web page related to the promotion program.

12. The non-transitory computer readable medium according to claim 9, wherein
the information about the mobile device includes intensity of the first signal detected by the mobile device, and
the content of the information is determined based on the intensity of the first signal.

13. The non-transitory computer readable medium according to claim 12, wherein
the content of the information is determined based on a time period during which the received intensity is greater than a predetermined value.

14. The non-transitory computer readable medium according to claim 9, wherein
the information about the mobile device includes time in a day when the first signal is detected by the mobile device, and
the content of the information is determined based on the time.

15. The non-transitory computer readable medium according to claim 9, wherein
the information about the user includes age, gender, purchase tendency of the user, and
the content of the information is determined based on at least one of the age, the gender, and the purchase tendency of the user.

16. The non-transitory computer readable medium according to claim 9, wherein the method further comprises:
storing information about the user including age, gender, purchase tendency of the user in association with identification information of the mobile device used by the user, wherein
the information about the mobile device includes the identification information, and
the content of the information is determined based on the information stored in association with the received identification information.

17. An information distribution system for distributing information to a mobile device carried by a user within a service location, comprising:
a communication unit configured to transmit a first signal towards the mobile device, and receive from the mobile device that is in range of communication, a second signal containing information about the mobile device or a user of the mobile device; and
a control unit configured to determine content of information related to services offered at the service location, based on the received information, wherein
the communication unit is further configured to transmit a third signal containing the determined content to the mobile device.

18. The information distribution system according to claim 17, wherein
the service location is a store, and
the content of the information includes information related to a promotion program of the store.

19. The information distribution system according to claim 17, wherein
the communication unit includes an access point connected to the control unit and one or more transmitters located within the service location and configured to wirelessly communicate the access point and the mobile device.

20. The information distribution system according to claim 17, wherein
the information about the mobile device includes intensity of the first signal detected by the mobile device, and
the content of the promotion information is determined based on the intensity of the first signal.
